(19) United States
(12) Patent Application Publication
(10) Pub. No.: US 2024/0403876 A1
(43) Pub. Date: Dec. 5, 2024

(54) SUB-MERCHANT IDENTIFICATION NUMBER (SMID) INGESTION

(71) Applicant: BREAD FINANCIAL PAYMENTS, INC., Columbus, OH (US)

(72) Inventors: Jessica JUERGENS, Columbus, OH (US); Laura JOYNER, Columbus, OH (US); Jess LAWRENCE, Westerville, OH (US); David SNIDER, Columbus, OH (US)

(73) Assignee: BREAD FINANCIAL PAYMENTS, INC., Columbus, OH (US)

(21) Appl. No.: 18/328,714

(22) Filed: Jun. 2, 2023

(51) Int. Cl. G06Q 20/40; G06Q 20/08; G06Q 40/02

(52) U.S. Cl. CPC G06Q 20/401; G06Q 20/0855; G06Q 40/02

(57) ABSTRACT

A system and method for sub-merchant identification number (SMID) ingestion is disclosed. The method receives, from merchant aggregator, a transaction authorization request for a credit account customer and automatically scrapes the transaction authorization request for data to identify a sub-merchant. The method automatically determines a reward value of the sub-merchant for the credit account customer and automatically credits the customer with the determined reward.

### BACKGROUND

As consumer expectations evolve, the ability for issuers to offer compelling value propositions that align with the experience consumers expect has become an even more important differentiator in driving customer loyalty. Currently, credit account issuers offering value propositions for their credit account programs are often unable to clearly identify transactions at a merchant level when made through merchant aggregators (e.g., Ticketmaster, Seatgeek, StubHub, PayPal, Square, etc.). That is, the merchant aggregator behind the transaction is identified to a credit account provider when a purchase is made, but the actual merchant (or sub-merchant) providing the transacted for goods is not usually identified by the merchant aggregator. This inability to clearly identify a merchant (or sub-merchant) used by the merchant aggregator facilitating the transaction creates a significant limitation in the ability to offer accelerated rewards earn on specific categories of transactions (merchants) processed through these aggregators.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of the components of the aggregated purchase environment, in accordance with an embodiment.

FIG. 2 is a block diagram of an example transaction authorization request, in accordance with an embodiment.

FIG. 3 is a block diagram of the credit provider system with sub-merchant identification number (SMID) ingestion, in accordance with an embodiment.

FIG. 4 is a flowchart of a method for SMID ingestion, in accordance with an embodiment.

FIG. 5 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

In the following discussion, the term “retailer” is used to define a company or conglomeration that includes one or more brands. The term “brand” refers to a specific section of the retailer that includes a number of stores. The term “store” refers to a single sales location, a store could be a physical store (e.g., brick and mortar) or it could be a virtual store (e.g., a location that is accessed via the web).

The term “customer” is used herein to describe an actual or potential consumer of the retailer's goods and/or services.

The term “co-branded account” is used herein to describe a general purpose open-end revolving line of credit which is established by a credit provider for an accountholder pursuant to the terms of a credit agreement and in accordance with credit account association rules and regulations, and marketed with retailer's mark and the trade names and/or logos of a credit account association. In one embodiment, a co-brand credit card has a major/well-known credit card provider bug in conjunction with a brand specific emblem. The co-brand credit card can be used anywhere (or almost anywhere) a credit card can be used. There can be rewards, offers, financing, etc. as customer incentive. It is an open-ended, revolving credit product. There is often a credit limit, you can purchase as long as there is credit available, it is paid down by the customer making payments (monthly, minimum, in-full, overtime, etc.), and it remains an open account indefinitely, e.g., until canceled by customer or by credit account provider.

In one embodiment, the co-branded credit account can have an associated physical card, e.g., a credit card that is carried by a customer and includes the credit account information required for a purchase. In one embodiment, the co-branded credit account can have an associated virtual card that can be stored in a mobile wallet or otherwise digitally stored by the customer and includes the credit account information required for a purchase. In one embodiment, the co-branded credit account can have both a physical card and a virtual card.

The term “private label credit card” (PLCC) is used herein to describe a credit account that is intended for use at a specific brand of stores. The PLCC is a type of revolving credit plan managed by a bank or commercial finance company. The PLCC is often issued without an expiration date. In one embodiment, a branded credit card or (PLCC)) is a brand specific credit account. It can be used at any store under the brand/retailer. In one embodiment, there may be lower credit limits than a co-branded credit card. In one embodiment, branded credit cards can include rewards, offers, financing, etc. as customer incentive. It is an open-ended, revolving credit product. There is often a credit limit, you can purchase as long as there is credit available, it is paid down by the customer making payments (monthly, minimum, in-full, overtime, etc.), and it remains an open account indefinitely, e.g., until canceled by customer or by credit account provider.

In one embodiment, the PLCC account can have an associated physical card, e.g., a credit card that is carried by a customer and includes the credit account information required for a purchase. In one embodiment, the PLCC account can have an associated virtual card that can be stored in a mobile wallet or otherwise digitally stored by the customer and includes the credit account information required for a purchase. In one embodiment, the PLCC account can have both a physical card and a virtual card.

In one embodiment, a PLCC can be part of a “universal PLCC” (UPLCC) which is a private label account that issues with an association logo on the back of the associated credit card, the UPLCC usually has limited use. In some cases, the UPLCC can be a part of a conglomerations of different brands that utilize the same card association. For purposes of clarity, in the following discussion the term PLCC is used to describe both the PLCC and the UPLCC.

The terms “cardholder” and “account holder” are used herein to describe a customer that has at least one credit account. As discussed herein, the cardholder could be a customer with a physical card, a virtual card, or both a physical and a virtual card that can be used to facilitate transactions with the credit account.

### Overview

The following discussion provides a novel approach for automatic sub-merchant Identification number (SMID) ingestion that automatically identifies a sub-merchant that provided the transacted for goods in a merchant aggregator transaction.

For example, many credit account value propositions are based on some sort of 3-2-1 point structure (or the like) that results in the customer earning gift cards that can be used at the brand. E.g., 3% back at the brand, 2% at some fixed and/or adjustable category, and 1% on everything else. Such a format tends allows the credit account provider to modify the middle category (e.g., the 2%) of the value proposition process for promotions, time periods, events, and the like. By providing a dynamic category (or categories) the credit account program can be used to drive promotions, events, customer specific rewards, and the like.

Importantly, the various embodiments of the present invention do not merely implement an existing processes on a computer. Instead, the present embodiments, as will be described and explained below in detail, provide a novel approach for automatic SMID ingestion that automatically identifies a sub-merchant that provided the transacted for goods in a merchant aggregator transaction and utilizes network relationships, communications, and interactivity to identify and provide a proffered reward to the appropriate customers. By using the aspects discussed herein, the operational network demands of the credit provides computer system is also reduced as the channels for requests, reviews, and rewards are moved from customer and sub-merchant and replaced with the operation of SMID ingestion and customer identification and reward being identified during the transaction authorization request.

Moreover, the embodiments do not recite a mathematical algorithm; nor do they recite a fundamental economic or longstanding commercial practice. Instead, they address a challenge to a credit account the top of wallet card, in a “what have you done for me lately” environment that has been created and continues to rapidly evolve in the Internet-centric connected world.

Thus, the embodiments do not merely recite the performance of some business practice known from the pre-Internet world along with the requirement to perform it on a computing device. Instead, the embodiments illustrate a novel, clearly applied, specific solution to maintain and promote customer loyalty in the realm of real-time offers from different credit account providers, which cardholders are continuously bombarded with, in the growing digital environment.

### Operation

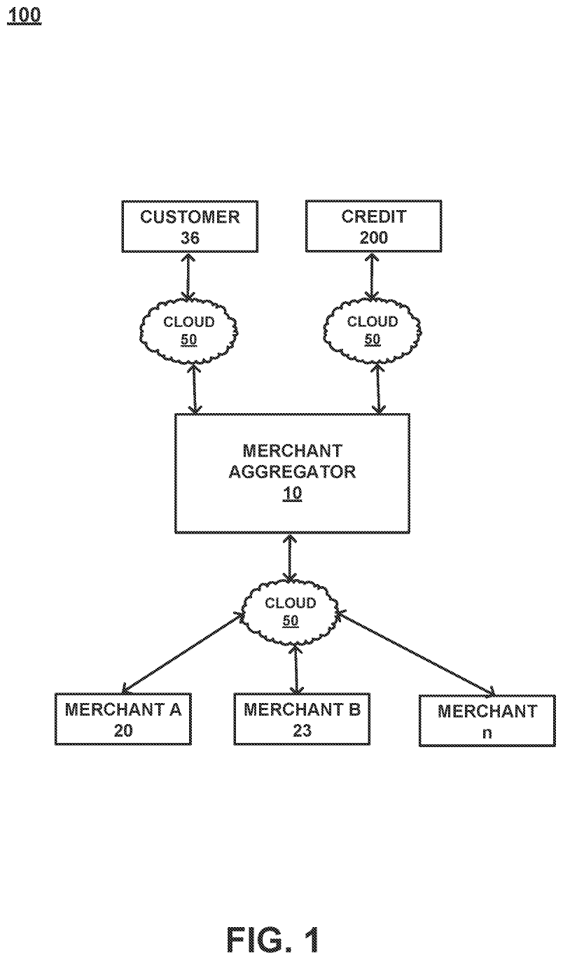

Referring now to FIG. 1, a block diagram of the components of the aggregated purchase environment 100 is shown. Although a number of components are shown, it should be appreciated that other, different, more, or fewer components may be used in different embodiments. In one embodiment, aggregated purchase environment 100 includes a merchant aggregator 10, one or more sub merchants (e.g., sub-merchant A 20, sub-merchant B 23, sub-merchant n, etc.), a customer 36, a credit account provider 200, and at least one network (e.g., cloud 50).

In one embodiment, a merchant aggregator 10 is an entity such as (e.g., Ticketmaster, Seatgeek, StubHub, PayPal, Square, etc.) that provides customer 36 with a single transaction location but which includes one or more merchants (hereinafter “sub-merchants”) providing the transacted for goods.

For example, a ticket merchant aggregator 10 might contract with a number of different sub-merchants such as a racetrack, an arena, a stadium, a pavilion, and the like. In so doing, the ticket merchant aggregator 10 would be able to provide customer 36 with a ticket to one or a number of events. In one embodiment, the events could be shows, races, concerts, and the like.

In one embodiment, the merchant aggregator 10 behind the transaction is identified as the party requesting authorization from the credit account provider 200 when a transaction is made, while the sub-merchant is paid by the merchant aggregator 10 and therefore does not need to obtain the purchase authorization from the credit account provider 200. As such, the credit account provider 200 will need to perform the unique automated process disclosed herein to identify the sub-merchant used by the merchant aggregator 10 and credit the customer with the appropriate reward based on the customer's reward system maintained by the credit account provider 200.

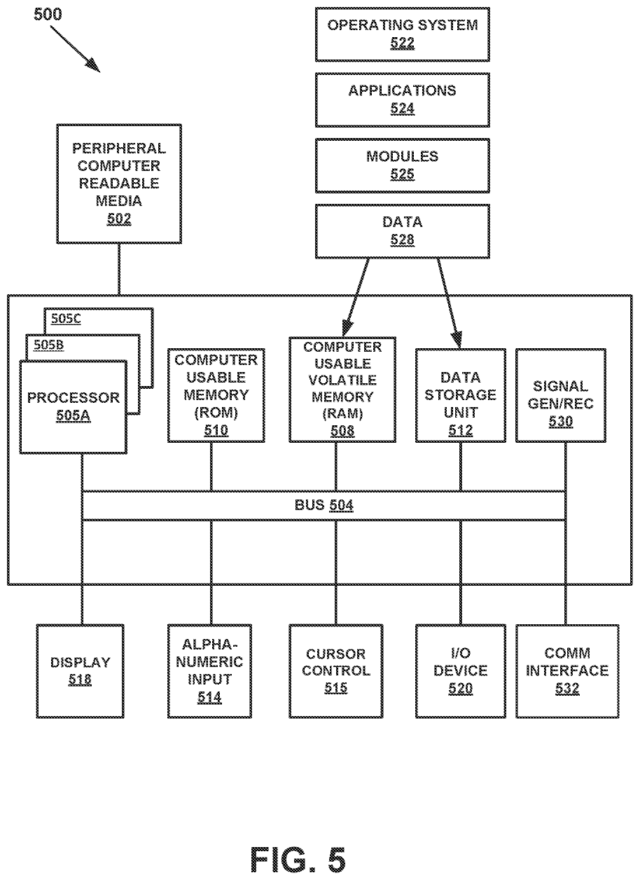

In one embodiment, merchant aggregator 10 includes a computing system with one or more components similar to the computing system described in FIG. 5. Merchant aggregator 10 can be a single machine, a virtual machine, a distributed system, a plurality of machines, or the like.

In one embodiment, sub-merchant A 20, B 23, and n include one or more components of a computing system similar to the computing system described in FIG. 5. In one embodiment, one, some, or all of sub-merchant A 20, B 23, and n communicate with merchant aggregator 10 over a network such as network 50.

In one embodiment, customer 36 is a customer's computing system such as a mobile device, laptop, desktop, tablet, or the like. In one embodiment, customer 36 uses a computer system with one or more components similar to the computing system described in FIG. 5. In one embodiment, the customer 36 computing system communicates with merchant aggregator 10 over a network such as network 50.

In one embodiment, credit account provider 200 include one or more components of a computing system similar to the computing system described in FIG. 5. Credit account provider 200 can be a single machine, a virtual machine, a distributed system, a plurality of machines, or the like. In one embodiment, credit account provider 200 communicates with merchant aggregator 10 over a network such as network 50.

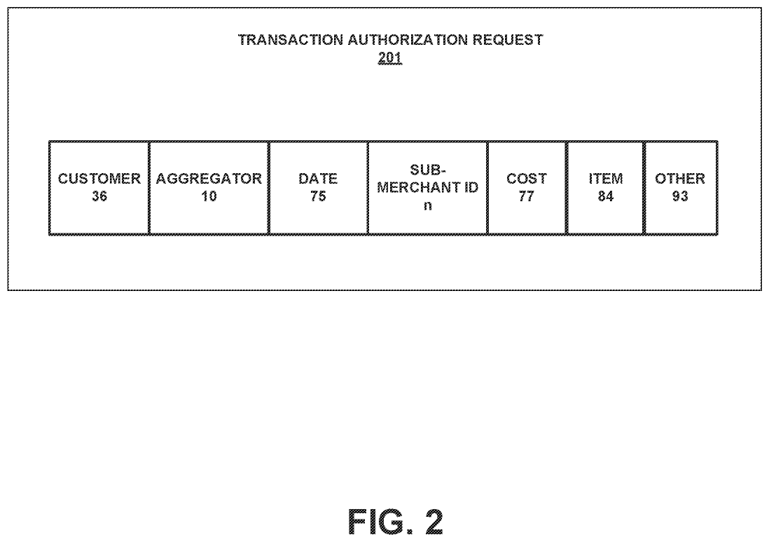

With reference now to FIG. 2, a block diagram of an example transaction authorization request 201 is shown in accordance with an embodiment. In one embodiment, transaction authorization request 201 includes one or more categories such as, but not limited to, customer 36, merchant aggregator 10, date 75, sub-merchant identifier (ID) n, cost 77, item 84, and other 93. Although an embodiment with a number of categories within transaction authorization request 201 is shown in FIG. 2, in another embodiment, the number of categories within transaction authorization request 201 may be more, fewer, different, or the like.

In general, customer 36 identifies the customer associated with the transaction. Merchant aggregator 10 identifies the specific merchant aggregator 10 associated with the transaction. Date 75 is a date of the transaction (it could be the date of actual occurrence of the transaction, the date of transaction recordation, a combination of the two, or the like.). Sub-merchant ID n is the identifier used by merchant aggregator 10 to identify the sub-merchant associated with the transaction. In one embodiment, the sub-merchant ID n is an alphanumeric identifier. Cost 77 indicates the amount spent on the transaction. Item 84 is the good and/or service acquired during the transaction. Other 93 refers to other data that could be included in the transaction authorization request 201 data such as, but not limited to, a transaction location (e.g., internet/in-store/address/store-identifier code, etc.), a transaction type (plastic card, digital wallet, etc.), a SKU (or other item identifier), a size, a description of the item, etc.

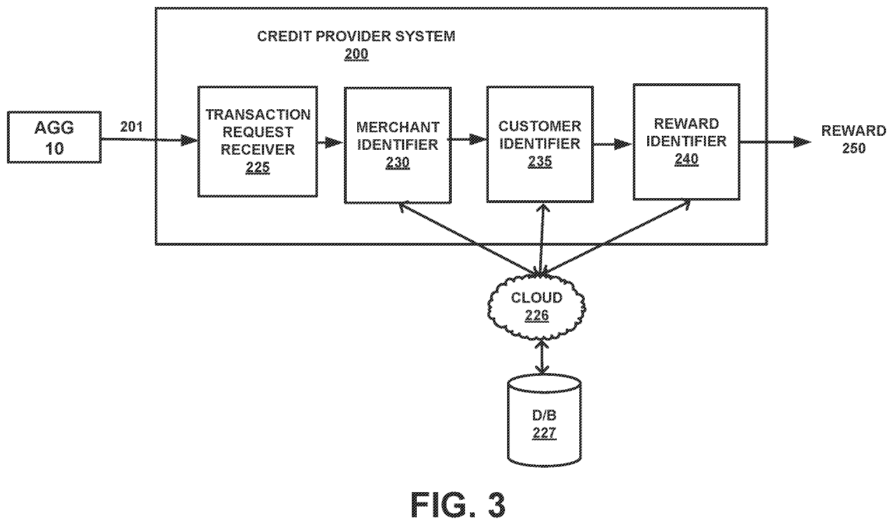

Referring now to FIG. 3, a block diagram of the credit provider system 200 with sub-merchant identification number (SMID) ingestion is shown in accordance with an embodiment. In one embodiment, credit provider system 200 includes transaction request receiver 225, sub-merchant identifier 230, customer identifier 235, reward identifier 240, and a database 227.

In one embodiment, credit provider system 200 can be a single machine, a virtual machine, a distributed system, a plurality of machines, or the like utilizing a network 226 connection between one or more of the components, the database 227, or the like. In one embodiment, network 226 is the Internet, a secure network, local area network, cellular network, a hybrid of two or more different networks, and the like.

Database 227 could be a local database, a virtual database, a cloud database, a plurality of databases, or a combination thereof. In one embodiment, database 227 includes customer information such as, but not limited to, shopping preferences, credit account(s), shopping history, and the like.

In one embodiment, transaction request receiver 225 receives the transaction authorization request 201 from the merchant aggregator 10.

In one embodiment, merchant identifier 230 obtains the sub-merchant ID n from the transaction authorization request 201 and accesses database 227 to perform a search to identify the sub-merchant. In one embodiment, merchant identifier 230 may use other of the pieces of data from transaction authorization request 201 in conjunction with (or in place of) sub-merchant ID n to perform the identification of the sub-merchant.

In one embodiment, customer identifier 235 obtains the customer account information from the customer 36 information provided in the transaction authorization request 201 and accesses database 227 to search and identify the customer's credit account.

In one embodiment, reward identifier 240 utilizes the identification of the sub-merchant, the customer account information from the customer 36 information, and/or any other purchase information (e.g., cost 308, item 310, date 305, other 312, and/or the like) provided in the transaction authorization request 201 to search database 227 and identify and/or determine the appropriate reward 250 for the customer 36.

Credit provider system 200 then provides the appropriate reward 250 to the customer 36. In one embodiment, the appropriate reward is posted to the customer's account. In one embodiment, the appropriate reward is provided to the customer.

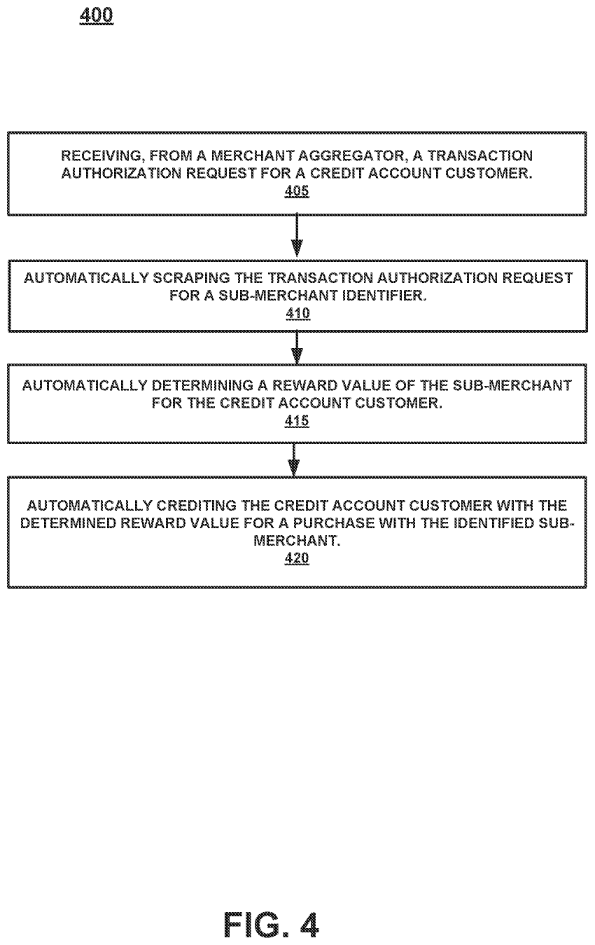

Referring now to FIG. 4, a flowchart 400 of a method for SMID ingestion is shown in accordance with an embodiment. For example, with reference now to FIGS. 1 and 4, merchant aggregator 10 receives a transaction request from customer 36 and interacts with one or more sub-merchant A 20, B 23, and n to determine if the goods or services of the transaction are available. Once the appropriate sub-merchant is identified, the merchant aggregator 10 will provide the goods and/or services information to the customer 36.

With reference now to FIGS. 1, 3, and 4, at 405 one embodiment receives, from merchant aggregator 10, a transaction authorization request 201 for a credit account customer 36. For example, when the customer 36 agrees to the transaction, the merchant aggregator 10 will provide a transaction authorization request 201 to credit account provider 200 for authorization, the credit account provider will provide the approval, and merchant aggregator 10 will cause the goods and/or services to be delivered from the sub-merchant to the customer 36. In one embodiment, the communications between the different components will occur over a network 124 (such as the Internet, a secure network, local area network, cellular network, and the like).

Referring now to FIGS. 2-4, at 410, one embodiment automatically scrapes the transaction authorization request 201 for a sub-merchant n identifier and/or information from transaction authorization request 201 in conjunction with (or in place of) sub-merchant ID n to perform the identification of the sub-merchant n.

For example, in one embodiment, the merchant aggregator 10 will assign a sub-merchant with a specific ID. In one embodiment, the sub-merchant ID n will be a constant for the sub-merchant regardless of the merchant aggregator facilitating the transaction. In one embodiment, the sub-merchant ID n will be a constant for the sub-merchant for a given merchant aggregator 10 facilitating the transaction but may change between different merchant aggregators.

In one embodiment, client provider system 200 will store merchant aggregator 10 identifiers in the database. In one embodiment, the sub-merchant IDs for one, some, or all of the merchants used by merchant aggregator 10 will be related to the merchant aggregator 10 in the database. In one embodiment, the merchant aggregator 10 will provide the sub-merchant IDs to the credit provider system 200 for storage in database 227.

In one embodiment, the merchant aggregator 10 will provide the sub merchant ID n as part of the transaction authorization request 201.

In one embodiment, if the merchant aggregator 10 does not provide the sub merchant ID n as part of the transaction authorization request 201, the credit provider system 200 will automatically query the merchant aggregator 10 to get the sub merchant ID n. In one embodiment, the query is sent prior to the authorization of the transaction. In one embodiment, the response from the merchant aggregator 10 is required before the transaction is authorized.

In one embodiment, if the merchant aggregator 10 does not provide the sub-merchant ID n as part of the transaction authorization request 201 (or does not identify their sub-merchant ID's), the credit provider system 200 will utilize other aspects of the transaction authorization request and/or other transaction information about the merchant aggregator 10 to automatically determine the identity of the sub-merchant. For example, if the transaction authorization request 201 provides an item 310 description (e.g., ZZ top tickets and a show date (or town, etc.)), the merchant identifier 230 of the credit provider system 200 could search database 227 for any other ZZ top tickets with the same show date (or town, etc.). If another transaction is identified as being provided by a sub-merchant (e.g., Awesome Stadium), the merchant identifier 230 would identify the sub-merchant as Awesome Stadium.

In one embodiment, if the merchant identifier 230 of the credit provider system 200 cannot identify the sub-merchant then no additional reward would be provided to the customer 36. However, if the customer 36 contacted the credit provider system 200 and identified the purchase as being from a sub-merchant (e.g., Awesome Stadium) that should have incurred a reward for the customer 36, in one embodiment, the merchant identifier 230 of the credit provider system 200 will update the identification system to now identify that purchase (e.g., ZZ top tickets and a show date (or location, etc.)) as being provided by sub-merchant (e.g., Awesome Stadium). In so doing, the merchant identifier 230 will then be able to identify any other transactions (e.g., ZZ top tickets and a show date (or town, etc.)) for any other customers as being provided by the now identified sub-merchant. Moreover, in one embodiment, the merchant identifier 230 could add information such as concerts at a given town, (or other location identifier), would likely be at a venue such as “Awesome Stadium”, which would allow the merchant identifier 230 to have a narrowed list of possible sub-merchants based on information provided in the transaction authorization request 201.

Thus, the merchant identifier 230 would build a “living” database that would grow in the realm of automated sub-merchant identification capabilities as the merchant identifier 230 learned from each piece of obtained data. As such, the capabilities of merchant identifier 230 would operate as an artificial intelligence (AI) that would continually learn from data provided by pluralities of merchants, merchant aggregators, customers, and the like until the merchant identifier 230 would become capable of automatically identifying (or making an educated guess) as to the underlying sub-merchant based on information gleaned from the transaction authorization request 201.

With reference now to FIGS. 3 and 4, at 415, one embodiment automatically determines a reward 250 value of the sub-merchant n for the credit account customer 36. For example, once the sub-merchant is identified, the reward identifier 240 of credit provider system 200 would search the customer 36 file to determine if customer 36 were to receive any reward (or any additional reward) for a purchase made to the identified sub-merchant. If the customer 36 is to receive a reward 250 (or any additional reward), then reward identifier 240 would provide the reward 250 to the customer 36.

Referring now to FIGS. 3 and 4, at 420, one embodiment automatically credits the credit account customer 36 with the determined reward 250 value for a purchase with the identified sub-merchant n. In one embodiment, the appropriate reward is posted to the customer's account. In one embodiment, the appropriate reward is provided to the customer.

### Example Computer System

With reference now to FIG. 5, portions of the technology for providing a communication composed of computer-readable and computer-executable instructions that reside, for example, in non-transitory computer-readable medium (or storage media, etc.) of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components described herein may be combined with some or all of the components of FIG. 5 to practice the present technology.

FIG. 5 illustrates an example computer system 500 used in accordance with embodiments of the present technology. It is appreciated that computer system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a disk, a compact disc, a flash drive, and the like coupled thereto.

Computer system 500 of FIG. 5 includes an address/data/control bus 504 for communicating information, and a processor 505A coupled to bus 504 for processing information and instructions. As depicted in FIG. 5, computer system 500 is also well suited to a multi-processor environment in which a plurality of processors 505A, 505B, and 505C are present. Conversely, computer system 500 is also well suited to having a single processor such as, for example, processor 505A. Processors 505A, 505B, and 505C may be any of various types of microprocessors. Computer system 500 also includes data storage features such as a computer usable volatile memory 508, e.g., random access memory (RAM), coupled to bus 504 for storing information and instructions for processors 505A, 505B, and 505C.

Computer system 500 also includes computer usable non-volatile memory 510, e.g., read only memory (ROM), coupled to bus 504 for storing static information and instructions for processors 505A, 505B, and 505C. Also present in computer system 500 is a data storage unit 512 (e.g., a magnetic disk drive, optical disk drive, solid state drive (SSD), and the like) coupled to bus 504 for storing information and instructions. Computer system 500 also can optionally include an alpha-numeric input device 514 including alphanumeric and function keys coupled to bus 504 for communicating information and command selections to processor 505A or processors 505A, 505B, and 505C. Computer system 500 also can optionally include a cursor control device 515 coupled to bus 504 for communicating user input information and command selections to processor 505A or processors 505A, 505B, and 505C. Cursor control device may be a touch sensor, gesture recognition device, and the like. Computer system 500 of the present embodiment can optionally include a display 518 coupled to bus 504 for displaying information.

Referring still to FIG. 5, display 518 of FIG. 5 may be a liquid crystal device, cathode ray tube, OLED, plasma display device or other display device suitable for creating graphic images and alpha-numeric characters recognizable to a user. Cursor control device 515 allows the computer user to dynamically signal the movement of a visible symbol (cursor) on display 518. Many implementations of cursor control device 515 are known in the art including a trackball, mouse, touch pad, joystick, non-contact input, gesture recognition, voice commands, bio recognition, and the like. In addition, special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

Computer system 500 is also well suited to having a cursor directed by other means such as, for example, voice commands. Computer system 500 also includes an I/O device 520 for coupling computer system 500 with external entities. For example, in one embodiment, I/O device 520 is a modem for enabling wired or wireless communications between computer system 500 and an external network such as, but not limited to, the Internet or intranet. A more detailed discussion of the present technology is found below.

Referring still to FIG. 5, various other components are depicted for computer system 500. Specifically, when present, an operating system 522, applications 524, modules 525, and data 528 are shown as typically residing in one or some combination of computer usable volatile memory 508, e.g. random-access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 525 in memory locations within RAM 508 and memory areas within data storage unit 512. The present technology may be applied to one or more elements of described computer system 500.

Computer system 500 also includes one or more signal generating and receiving device(s) 530 coupled with bus 504 for enabling computer system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one (or more) communication interface 532 for coupling information to and/or from computer system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g., via radio frequency) couple computer system 500 with another device, such as a mobile phone, radio, or computer system.

Computer system 500 is only one example of a suitable computing environment and is not intended to suggest any limitation as to the scope of use or functionality of the present technology. Neither should the computing environment be interpreted as having any dependency or requirement relating to any one or combination of components illustrated in the example computer system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A computer-implemented method for sub-merchant identification number (SMID) ingestion, said method comprising:
receiving, from merchant aggregator, a transaction authorization request for a credit account customer;
automatically scraping the transaction authorization request for data to identify a sub-merchant;
automatically determining a reward value of the sub-merchant for the credit account customer; and
automatically crediting the credit account customer with the determined reward.

2. The method of claim 1, wherein the data to identify the sub-merchant comprises:
obtaining a sub-merchant identifier from said transaction authorization request; and
searching, in a database, said sub-merchant identifier in conjunction with said merchant aggregator to identify said sub-merchant.

3. The method of claim 1, wherein the data to identify the sub-merchant comprises:
obtaining a merchant aggregator identifier from said transaction authorization request;
obtaining a sub-merchant identifier from said transaction authorization request; and
searching, in a database, said sub-merchant identifier in conjunction with said merchant aggregator to identify said sub-merchant.

4. The method of claim 1, wherein the data to identify the sub-merchant comprises:
obtaining an item description from said transaction authorization request; and
automatically determining a reward value based on said item description and said identified sub-merchant.

5. The method of claim 1, wherein the data to identify the sub-merchant comprises:
obtaining a cost from said transaction authorization request; and
automatically determining a reward value based on said cost and said identified sub-merchant.

6. The method of claim 1, wherein the data to identify the sub-merchant comprises:
obtaining a date from said transaction authorization request; and
automatically determining a reward value based on said date and said identified sub-merchant.

7. The method of claim 1, wherein the data to identify the sub-merchant comprises:
obtaining an item description from said transaction authorization request;
obtaining a cost from said transaction authorization request; and
automatically determining a reward value based on said item description, said cost, and said identified sub-merchant.

8. The method of claim 1, wherein the data to identify the sub-merchant comprises:
obtaining a date from said transaction authorization request;
obtaining an item description from said transaction authorization request;
obtaining a cost from said transaction authorization request; and
automatically determining a reward value based on said date, said item description, said cost, and said identified sub-merchant.

9. A non-transitory computer-readable storage medium having instructions embodied therein that when executed cause a computer system to perform a method comprising:
receiving, from merchant aggregator, a transaction authorization request for a credit account customer;
automatically scraping the transaction authorization request for data to identify a sub-merchant;
automatically determining a reward value of the sub-merchant for the credit account customer; and
automatically crediting the credit account customer with the determined reward.

10. The non-transitory computer-readable storage medium of claim 9, further comprising:
obtaining a sub-merchant identifier from said transaction authorization request; and
searching, in a database, said sub-merchant identifier in conjunction with said merchant aggregator to identify said sub-merchant.

11. The non-transitory computer-readable storage medium of claim 9, further comprising:
obtaining a merchant aggregator identifier from said transaction authorization request;
obtaining a sub-merchant identifier from said transaction authorization request; and
searching, in a database, said sub-merchant identifier in conjunction with said merchant aggregator to identify said sub-merchant.

12. The non-transitory computer-readable storage medium of claim 9, further comprising:
obtaining an item description from said transaction authorization request; and
automatically determining a reward value based on said item description and said identified sub-merchant.

13. The non-transitory computer-readable storage medium of claim 9, further comprising:
obtaining a cost from said transaction authorization request; and
automatically determining a reward value based on said cost and said identified sub-merchant.

14. The non-transitory computer-readable storage medium of claim 9, further comprising:
obtaining a date from said transaction authorization request; and
automatically determining a reward value based on said date and said identified sub-merchant.

15. A computing system to manage information pertaining to anonymous and/or known customer activity both in store and online comprising:
a memory; and
one or more processors, the one or more processors to:
receive, from merchant aggregator, a transaction authorization request for a credit account customer;
automatically scrape the transaction authorization request for data to identify a sub-merchant;
automatically determine a reward value of the sub-merchant for the credit account customer; and
automatically credit the credit account customer with the determined reward.

16. The computing system of claim 15, wherein the one or more processors are further to:
obtain a merchant aggregator identifier from said transaction authorization request;
obtain a sub-merchant identifier from said transaction authorization request; and
search, in a database, said sub-merchant identifier in conjunction with said merchant aggregator to identify said sub-merchant.

17. The computing system of claim 15, wherein the one or more processors are further to:
obtain an item description from said transaction authorization request; and
automatically determine a reward value based on said item description and said identified sub-merchant.

18. The computing system of claim 15, wherein the one or more processors are further to:
obtain a cost from said transaction authorization request; and
automatically determine a reward value based on said cost and said identified sub-merchant.

19. The computing system of claim 15, wherein the one or more processors are further to:
obtain a date from said transaction authorization request; and
automatically determine a reward value based on said date and said identified sub-merchant.

20. The computing system of claim 15, wherein the one or more processors are further to:
obtain a date from said transaction authorization request;
obtain an item description from said transaction authorization request;
obtain a cost from said transaction authorization request; and
automatically determine a reward value based on said date, said item description, said cost, and said identified sub-merchant.
